(19) United States
(12) Patent Application Publication
(10) Pub. No.: US 2003/0220960 A1
(43) Pub. Date: Nov. 27, 2003

(54) System and method for processing data over a distributed network

(76) Inventors: Jeff S. Demoff, Erie, CO (US); Carol Harrisville-Wolff, Louisville, CO (US); Alan S. Wolff, Louisville, CO (US)

Correspondence Address: HOGAN & HARTSON LLP, ONE TABOR CENTER, SUITE 1500, 1200 SEVENTEEN ST., DENVER, CO, 80202, US

(21) Appl. No.: 10/152,667

(22) Filed: May 21, 2002

(51) Int. Cl. G06F 9/00

(52) U.S. Cl. 709/104; 709/105

(57) ABSTRACT

A system and method for processing data over a distributed network is disclosed. The distributed network includes a plurality of nodes and a central machine coupled to the nodes. The central machine receives a data space and partitions the data space into data blocks. The data blocks are sent to the nodes. Each node analyzes a received data block using an optimization algorithm forwarded by the central machine. Results that may be of interest to other data blocks are detected during the analysis and forwarded from the nodes to the central machine at an interval. The central machine forwards the results to the other nodes within the distributed network in order to update their processing of the data blocks. The updating activity continues until the data blocks have been processed.

### BACKGROUND OF THE INVENTION

1. Field of the Invention

The present invention relates to processing data over a distributed network, and, more particularly, the invention relates to an efficient distribution scheme for intensive computational loads within the distributed network.

2. Discussion of the Related Art

As computers and processors are able to process larger and larger amounts of data, the number of numerically intensive operations for these computers and processors keep growing. Known computers support many computational intensive tasks, such as encryption/decryption. A computer performs these tasks by searching through the problem space and trying as many combinations and permutations as possible. This process may be done by “brute force”, such as one combination or permutation at a time, until the desired result is achieved. Computationally intensive problems may present too much data for one computer to handle effectively. For example, the computer may be limited by the capacity of its processors and memory to execute the vast number of operations needed to complete an analysis or solve a problem.

One potential solution partitions the problem space into chunks and sends the partitions to nodes within a distributed cluster. The nodes then may execute their received chunk of data. The cluster may be a network known as a n-node cluster. Each node works on a part of the problem space. A central machine, such as a server, is responsible for collecting and formulating the results from the different nodes. Once a node is finished with its task, then another task is assigned to the node until the problem is solved, or all data analyzed.

Another potential solution generates and applies optimization algorithms and techniques to the problem solving process. The optimization operations exist on one computer and are recursive such that the results of the algorithms may be fed back into the algorithms, and the new inputs of data, for processing. Over time, a good solution may be developed and the solution may be implemented using the optimization algorithms. A potential drawback may be all processing operations and optimization is performed on one machine. Another potential drawback, however, is running the optimization algorithms prior to distributing data over the network may increase processing time and efficiency.

As the size and demands for computational intensive processing increases, the above-described operations may not provide enough capacity to handle the large amounts of data. Thus, networks may bog down in processing data or performing optimization operations to solve problems, wherein any efficiency is lost.

### SUMMARY OF THE INVENTION

Accordingly, the disclosed embodiments are directed to a system and method for processing data over a distributed network.

Additional features and advantages of the invention will be set forth in the disclosure that follows, and in part will be apparent from the disclosure, or may be learned by practice of the invention. The objectives and other advantages of the disclosed embodiments will be realized and attained by the structure particularly pointed out in the written description and claims hereof as well as the appended drawings.

According to an embodiment, a system for processing a data workspace over a distributed network is disclosed. The system includes a central machine to partition the data workspace into data blocks. The system also includes a plurality of nodes to receive the data blocks. The plurality of nodes are coupled to the central machine. The system also includes a plurality of optimization algorithms on the plurality of nodes. The plurality of optimization algorithms executes against the data blocks and reports results to the central machine at periodic intervals.

According to another embodiment, a method for processing a data space over a distributed network having a plurality of nodes is disclosed. The method includes partitioning the data space into a plurality of data blocks on a central machine. The method also includes sending the plurality of data blocks to the plurality of nodes. The method also includes analyzing the plurality of data blocks at the plurality of nodes. The method also includes executing a plurality of optimization algorithms at the plurality of nodes. Each of the plurality of optimization algorithms correlates to each of the plurality of data blocks. The method also includes updating the plurality of optimization algorithms at an interval from the central machine.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 illustrates a distributed network having nodes in accordance with an embodiment of the present invention.

FIG. 2 illustrates a distributed network for optimizing computational operations in accordance with an embodiment of the present invention.

FIG. 3 illustrates a flowchart for processing data in distributed network in accordance with an embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

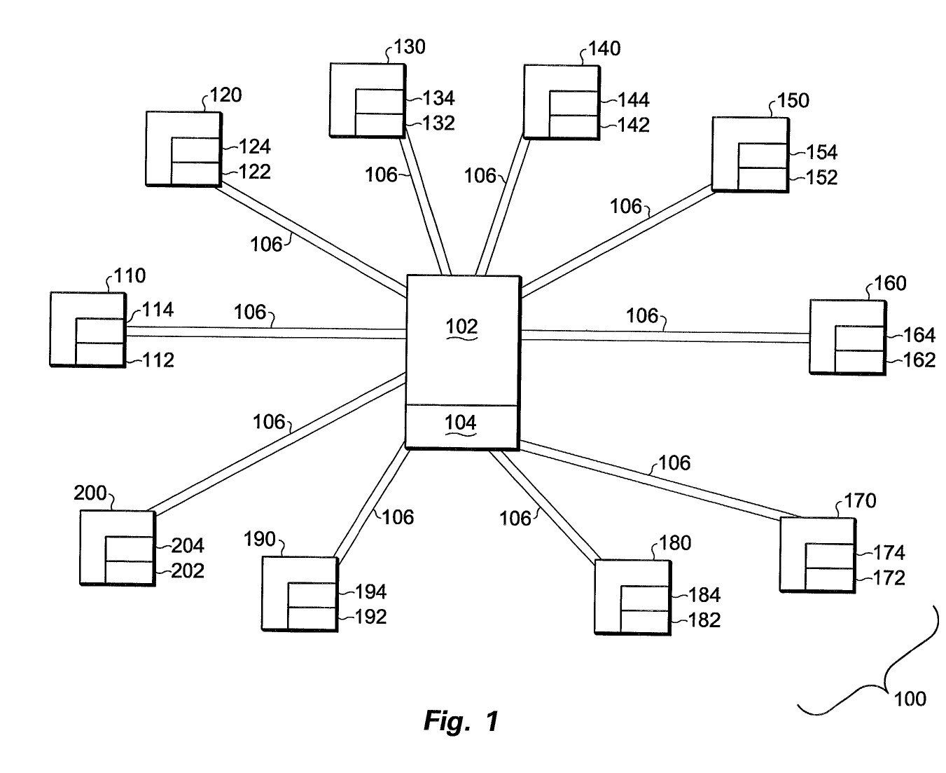

FIG. 1 depicts a distributed network 100 having nodes in accordance with an embodiment of the present invention. Distributed network 100 also may be known as a distributed system. Distributed network 100 facilitates data exchange between the nodes, central servers, computing platforms, and the like. According to the disclosed embodiments, distributed network 100 includes nodes 110, 120, 130, 140, 150, 160, 170, 180, 190, and 200. Distributed network 100, however, is not limited as to the number of nodes, and may be any number of nodes. Nodes 110-200 may be computers, machines, or any device having a processor and a memory to store instructions for execution on the processor. Such devices may include, but are not limited to, desktops, laptops, personal digital assistants, wireless devices, cellular phones, minicomputers, and the like. Further, nodes 110-200 do not have to be in the same location, and each node may be distributed in different locations.

Distributed network 100 also includes central machine 102. Central machine 102 may be a server, or any device having a processor and a memory to store instructions to be executed on the processor. Preferably, central machine 102 has memory to store data from nodes 110-200. Further, central machine 102 stores data to be sent to nodes 110-200. Central machine 102 may control functions on nodes 110-200, distribute information and data to nodes 110-200, monitor nodes 110-200, and the like. Central machine 102 is coupled to nodes 110-200 by data pipes 106. Data pipes 106 may be any medium able to transmit and exchange data between nodes 110-200. Data pipes 106 may be coaxial cable, fiber optic line, infrared signals, and the like. Additional data pipes (not shown) may couple nodes 110-200 with each other.

Central machine 102 also provides management to perform problem solving involving large amounts of data. Distributed network 100 may be tasked to analyze a program or a data set that results in operations that are computationally extensive, as disclosed above. For example, distributed network 100 may receive encryption/decryption tasks, or commands to solve a code. These computationally extensive tasks require numerous combinations and permutations of data to solve a problem. Another example of a complex problem space may be modeling complex systems, such as proteins, genes, games, and the like.

Central machine 102 may partition the problem space into blocks of data. Central machine 102 sends the different blocks of data to nodes 110-200. Thus, each node receives a block of data that is different than the other nodes. The blocks of data may be the same size, or may differ in size according to the node used. For example, node 110 may receive a gigabyte of data to analyze and node 120 may receive another gigabyte of data. Alternatively, node 120 may receive two sigabytes of data. Central machine 102 includes optimization agent 104 to coordinate and process the results of the distributed data blocks. Optimization agent 104 may be a program or software code that executes on central machine 102. Optimization agent 104 may execute when distributed network 100 is tasked to solve a computationally extensive problem, or queried by central machine 102.

Optimization agent 104 coordinates the analysis of the data blocks in conjunction with distributed node optimization agents. Nodes 110, 120, 130, 140, 150, 160, 170, 180, 190 and 200 include node optimization agents 112, 122, 132, 142, 152, 162, 172, 182, 192 and 202, respectively. Optimization agents 112-202 receive optimization algorithms from central machine 102. Optimization agents 112-202 also communicate and coordinate with central machine 102 on the status of the data blocks as operations are being performed. Preferably, node optimization agents 112-202 indicate the progress and status of analysis of the data blocks at regular intervals, such as 0.1 sec. Thus, distributed network 100 is not saturated with data packets and traffic from nodes 110-200. Further, optimization agent 104 may plan and coordinate according to a known schedule by receiving status information from node optimization agents 112-202 at regular intervals.

Nodes 110, 120, 130, 140, 150, 160, 170, 180, 190 and 200 also include memory spaces 114, 124, 134, 144, 154, 164, 174, 184, 194 and 204, respectively. Memory spaces 114-204 may store optimization algorithms distributed by central machine 102. Memory spaces 114-204 occupy memory on nodes 110-200. Nodes 110-200 may receive optimization algorithms from optimization agent 104 to execute against the distributed data blocks. As opposed to running the optimization algorithms against the entire workspace data, nodes 110-200 execute the optimization algorithms against the discrete data blocks received by node optimization agents 112-202. Memory spaces 114-204 also may store the data blocks of the problem workspace. Alternatively, the data blocks may be stored at other memory locations on nodes 110-200. Preferably, nodes 110-200 receive the same optimization algorithm. Alternatively, nodes 110-200 may not receive the same optimization algorithm. For example, node 130 may receive a certain optimization algorithm while node 140 may receive a different optimization algorithm that pertains to the data block received from central machine 102.

The optimization algorithms may indicate statistically those data sets or solutions that are “good” solutions for the problem workspace. Further, the optimization algorithms may measure what is happening on any particular part data block of the problem workspace to determine whether the analysis is proceeding along the correct solution path. The optimization algorithm may determine whether the data being analyzed resembles a good solution or an incorrect solution. Central machine 102 collects computational information and optimization results as the optimization algorithms execute via optimization agent 104.

Node optimization agents 112-202 communicate the progress of the analysis of the data blocks and the results of the optimization algorithms. When a particular data piece of interest is discovered by an optimization algorithm, then the result is communicated to optimization agent 104. Central machine 102 then may forward a result occurring from the received data to nodes 110-200. Nodes 110-200 may act accordingly using optimization agents 112-202. For example, if node 180 determines a favorable solution may exist in a certain location of the data block, then node optimization agent 182 may convey that information to central machine 102 via optimization agent 104. Other locations within the workspace that correlate to the indicated location may provide favorable solutions to the problem. Central machine 102 may send a message to the optimization algorithms in memory spaces 114, 124, 134, 144, 154, 164, 174, 194 and 204 to analyze these locations within their data blocks first.

Thus, a feedback loop may be established between central machine 102 and nodes 110-200. Preferably, node optimization agents 112-202 communicate more frequently with optimization agent 104 on the progress of the optimization algorithms than the normal status reports from nodes 110-200 on the analysis of the data blocks. Any favorable optimization information should be received in an expedient manner. Alternatively, node optimization agents 112-202 may communicate directly with each other. Referring to the example above, node 180 may broadcast the location of the favorable solution within its data block throughout distributed network 100. Thus, the operations processing the workspace may determine when and how to place the more favorable possible solutions first and the least favorable solutions last.

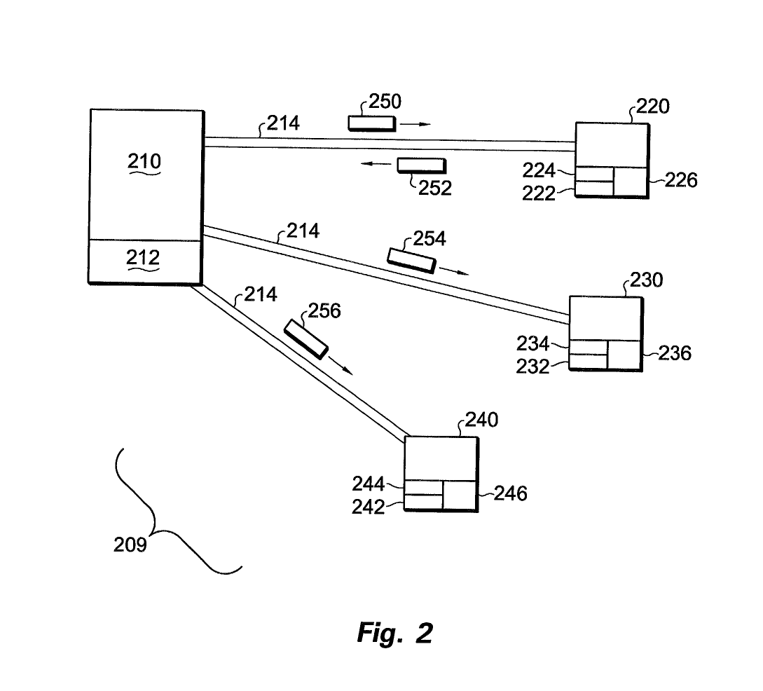

FIG. 2 depicts a distributed network 209 for optimizing computational operations in accordance with an embodiment of the present invention. The computational operations may pertain to analyzing a problem workspace that results in complex numerical evaluations, such as multiple combinations and permutations. A problem workspace may be searched and analyzed to find a favorable solution, such as a code. Further, the problem workspace may model a complex system or item that results in many different data sets.

Central machine 210 includes optimization agent 212 to facilitate coordination of analyzing the problem workspace. Data pipes 214 couple central machine 210 to nodes 220, 230, and 240. Nodes 220, 230 and 240 are located within distributed network 209. Distributed network 209 may include additional nodes than the nodes depicted in FIG. 2. Further, distributed network 209 may include other machines, servers, computers, and the like.

Node 220 includes a node optimization agent 222, an optimization algorithm 224, and a data block 226. Node 230 includes a node optimization agent 232, an optimization algorithm 234, and a data block 236. Node 240 includes a node optimization agent 242, an optimization algorithm 244, and a data block 248. Data blocks 226, 236 and 246 may be discrete partitions of the problem workspace. Central machine 210 sends data blocks 226, 236 and 246 to nodes 220, 230 and 240, respectively. Node optimization agents 222, 232 and 242 report to optimization agent 212 on central machine 210 the status of analyzing data blocks 226, 236 and 246. All of the components on nodes 220, 230 and 240 may be stored in memory.

Nodes 220, 230 and 240 cycle through data blocks 226, 236 and 246. Optimization algorithms 224, 234 and 244 run against the processing operations on data blocks 226, 236 and 246. Optimization algorithms 224, 234 and 244 measure the progress of analysis within data blocks 226, 236 and 246 to determine whether a particular solution path is good or bad. Optimization algorithms 224, 234 and 244 may be local versions of an optimization algorithm resident on central machine 210. Central machine 210 may forward the local optimization algorithms to nodes 220, 230 and 240. Optimization algorithms 224, 234 and 244 may be recursive such that the results of the algorithms are routed to the other algorithms that have different inputs, or data blocks. Node optimization agents 222, 232 and 242 coordinate the optimization operations with central machine 210.

Data blocks 226, 236 and 246 and optimization algorithms 224, 234 and 244 may be forwarded to nodes 220, 230 and 240 over data pipes 214. Data pipes 214 also may transmit data packets or messages from nodes 220, 230 and 240 to central machine 210. Nodes 220, 230 and 240 send status updates at periodic intervals with results from optimization algorithms 224, 234 and 244. Further, nodes 220, 230 and 240 indicate to central machine 210 when a data block is completed. Central machine 210 then may forward another data block of the problem workspace to that node for additional processing. As updates are received, central machine 210 may send the results to the other nodes within distributed network 209.

For example, node 220 may receive data block 226 of a problem workspace partitioned by central machine 210. Node 220 also receives optimization algorithm 224 from central machine 210. Node 220 places data block 226 and optimization algorithm in a memory space or spaces. Node 220 begins processing and analyzing data block 226 for potential solutions. Optimization algorithm 224 determines about a third of the way through data block 226 that a chain of potential solutions may not work. Node optimization agent 222 notes this information and forwards the information as data packet 252 to central machine 210. Central machine 210 via optimization agent 212 may forward the noted information to the other nodes within distributed network 209. Data packet 254 transmits the noted optimization information to node 230. Optimization algorithm 234 is updated and uses the information in processing data block 236. If optimization algorithm 234 encounters the same data path as noted by optimization algorithm 224, then it may act accordingly. In this instance, the data path may be placed at the bottom of the processing order. The same process may be provided for node 240 that receives data packet 256 and updates optimization algorithm 244.

In another example, node 220 is executing optimization algorithm 224 while analyzing data block 226, as disclosed above. A location in memory space, such as a memory address, is found to be empty. Optimization algorithm 224 recognizes memory locations correlating to this one are highly likely to be empty as well. Node optimization agent 222 sends data packet 252 to central machine 210 that the noted memory location is empty. Central machine 210, having the parent optimization algorithm, determines that correlating memory locations have a high probability of being empty. Thus, central machine 210 via optimization agent 212 may broadcast data packets 250, 254, and 256 to their respective nodes. Optimization algorithms 224, 234, and 244 updated themselves with this information, and place the correlating memory locations at the bottom of the list of memory locations to search, as the probability of not finding a solution is high according to the optimization algorithms.

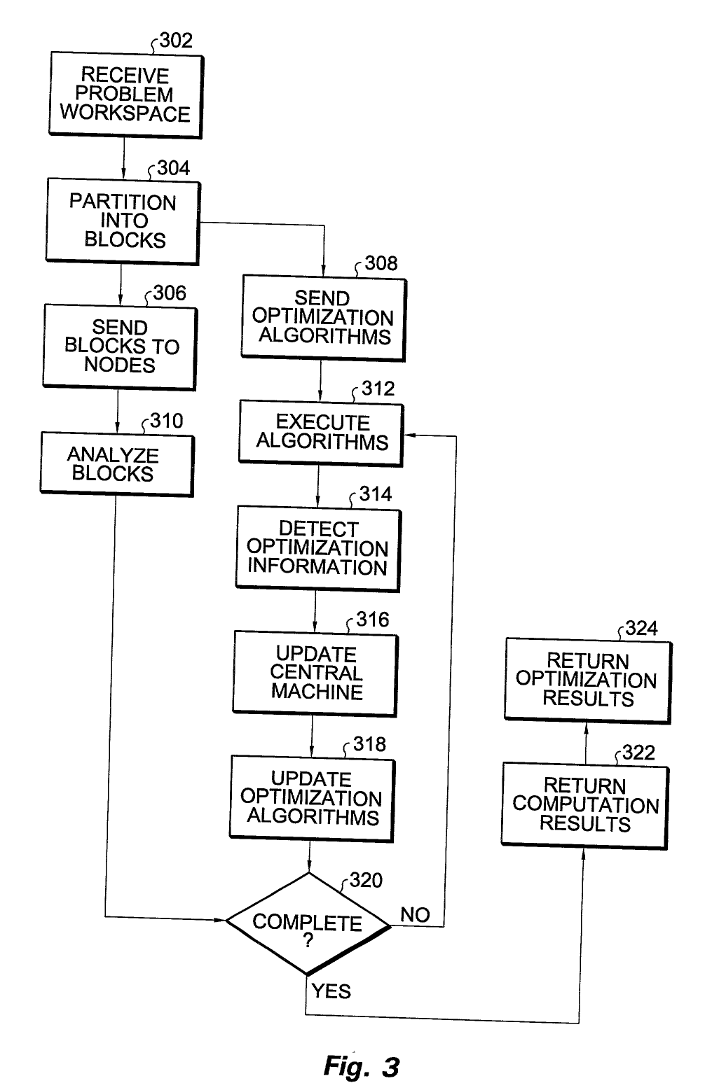

FIG. 3 depicts a flowchart for processing data in a distributed network in accordance with an embodiment of the present invention. Step 302 executes by receiving a problem workspace at a central machine, or server, within the distributed network. The problem workspace may be a large data set that results in combinations and permutations of the data to solve a problem, such as an encryption code. Preferably, the problem workspace is too large to be handled efficiently on the central machine.

Step 304 executes by partitioning the problem workspace into data blocks. The data blocks may be partitioned into equal sizes, or, alternatively, may be partitioned into unequal sizes. The number of partitions may be equal to the number of nodes within the distributed network, or a subset thereof. Preferably, the number of partitions does not exceed the number of nodes, though the disclosed embodiments may process the problem workspace in this manner. Step 306 executes by sending the data blocks to the nodes within the distributed network. Thus, the processing responsibilities are distributed among the resources within the network. Step 308 executes by sending optimization algorithms copied from an optimization algorithm on the central machine to the nodes as well.

Step 310 executes by analyzing the partitioned data blocks at the nodes. Each node executes the combinations and permutations of the data to find a solution, determine specified values, and the like. Step 312 executes by executing the optimization algorithms as the analysis of the data blocks occurs. In other words, the optimization algorithms may execute “against” the data blocks. Step 314 executes by detecting optimization information during the data block analysis. The optimization algorithms may evaluate the results of the data block processing to determine whether any optimization criteria has been met. The optimization algorithms may keep a history of the results to determined trends or biases in the data. The optimization algorithms should note those results that potentially impact other data within the problem workspace that may or may not be within the data block at that particular node.

Step 316 executes by updating the central machine with optimization information and results at periodic intervals. Each node has a node optimization agent that communicates with the central machine, or with other nodes. At regular intervals, any optimization information noted in step 314 is forwarded to the central machine. The central machine may update its optimization algorithm in accordance with the received information. Step 318 executes by updating the optimization algorithms at the nodes with the information received at the central machine. The central machine may send messages or commands over the network to each node. The optimization algorithms receive the information and may update their data. Further, the optimization algorithm may modify the data block analysis in accordance with the received information. For example, memory locations may be moved to the top or bottom of the problem set depending on the probability of finding a solution or desired data set.

Step 320 executes by determining whether the analysis of the data block at a node is complete. The data block is examined to see if all locations have been analyzed and all combinations and permutations performed on the data. If no, then step 312 executes, as disclosed above. If yes, then step 322 executes by returning the computational results of the analysis of the data block to the central machine. Potential solutions and other data may be returned at the completion of the analysis. Step 324 executes by returning the optimization results to the central machine. Once the central machine receives the results of the optimization algorithms, it may allow the optimization algorithm to be updated before resending the algorithm to the nodes.

Thus, in accordance with the disclosed embodiments, a novel system, network and method are disclosed that allows optimization algorithms to improve processing within a distributed network. The optimization algorithms enable a feedback loop with a central machine to update and optimize the processing in a recursive manner. Nodes, representing various computing platforms, may receive partitioned blocks of a problem workspace and an optimization algorithm to be used in processing the data block. At specified intervals, the optimization algorithms update the central machine as to information bearing on the probability of potential solutions within the workspace. The central machine then updates the optimization algorithms executing on the nodes. Though potentially not as efficient as executing the workspace on a single machine, the disclosed embodiments may lower processing costs and allow parallel computation to reduce processing time. Further, the disclosed embodiments make use of potentially fallow resources within the network.

It will be apparent to those skilled in the art that various modifications and variations can be made in the wheel assembly of the present invention without departing from the spirit or scope of the invention. Thus, it is intended that the present invention covers the modifications and variations of this invention provided that they come within the scope of any claims and their equivalents.

What is claimed:

1. A system for processing a data workspace over a distributed network, comprising:
a central machine to partition said data workspace into data blocks;
a plurality of nodes to receive said data blocks, wherein said plurality of nodes are coupled to said central machine; and
a plurality of optimization algorithms on said plurality of nodes, wherein said plurality of optimization algorithms executes against said data blocks and reports results to said central machine at periodic intervals.

2. The system of claim 1, further comprising an optimization agent on said central machine to exchange information between said central machine and said plurality of optimization algorithms.

3. The system of claim 1, wherein said plurality of optimization algorithms is sent to said plurality of nodes with said data blocks.

4. The system of claims 1, wherein said central machine updates said nodes with said results from said plurality of optimization algorithms.

5. The system of claim 1, wherein said plurality of optimization algorithms is copied from an optimization algorithm on said central machine.

6. The system of claim 1, further comprising a plurality of node optimization agents on said plurality of nodes, wherein said plurality of node optimization agents are coupled to said central machine.

7. The system of claim 1, wherein said plurality of nodes includes at least two node.

8. The system of claim 1, wherein said results are forwarded to said plurality of nodes for processing said data blocks.

9. A system for analyzing a data space within a distributed network having a plurality of nodes coupled to a central machine, comprising:
a first node from said plurality of nodes to process a data block partitioned from said data space;
an optimization algorithm received from said central machine to execute on said first node in correlation with said data block;
a node optimization agent on said first node to report to said central machine a result of said optimization algorithm and to update said plurality of nodes with said result.

10. The system of claim 9, wherein said result is a data packet from said first node.

11. The system of claim 9, further comprising a second node from said plurality of nodes, wherein said second node receives said result from said central machine.

12. The system of claim 11, wherein said second node updates another optimization algorithm with said result such that an analysis of another data block on said second node accounts for said result.

13. The system of claim 12, wherein said another optimization algorithm is received from said central machine.

14. The system of claim 12, wherein said another optimization algorithm is a copy of said optimization algorithm.

15. The system of claim 9, further comprising an optimization agent on said central machine to coordinate data exchange from said central machine to said plurality of nodes.

16. A method for processing a data space over a distributed network having a plurality of nodes, comprising:
partitioning said data space into a plurality of data blocks on a central machine;
sending said plurality of data blocks to said plurality of nodes;
analyzing said plurality of data blocks at said plurality of nodes;
executing a plurality of optimization algorithms at said plurality of nodes, wherein each of said plurality of optimization algorithms correlate to each of said plurality of data blocks; and
updating said plurality of optimization algorithms at an interval from said central machine.

17. The method of claim 16, further comprising detecting optimization information from said plurality of optimization algorithms.

18. The method of claim 16, further comprising receiving said data space at said distributed network.

19. The method of claim 16, further comprising sending said plurality of optimization algorithms to said plurality of nodes from said central machine.

20. The method of claim 16, further comprising updating said central machine at another interval with results from said plurality of optimization algorithms.

21. The method of claim 16, further comprising determining whether said analyzing step is complete.

22. The method of claim 21, further comprising returning computation results to said central machine.

23. The method of claim 21, further comprising returning optimization results to said central machine.

24. A method for updating an optimization algorithm on a node within a distributed network, comprising:
receiving an update from a central machine coupled to said node, wherein said node analyzes a data block according to said optimization algorithm;
determining whether said update is applicable to said data block; and
modifying the order of analysis of said data block in accordance with said update.

25. The method of claim 24, further comprising forwarding a result from said optimization algorithm to said central machine.

26. The method of claim 25, wherein said forwarding includes forwarding at an interval.

27. The method of claim 24, further comprising receiving said optimization algorithm at said node from said central machine.

28. The method of claim 24, further comprising receiving said data block at said node from said central machine.

29. The method of claim 24, wherein said distributed network includes a plurality of nodes.

30. A method for processing data over a distributed network, comprising:
partitioning a data space into data blocks;
distributing said data blocks to nodes within said distributed network;
receiving optimization algorithms at said nodes from a central machine within said distributed network;
analyzing said data blocks at said nodes using said optimization algorithms;
forwarding results from said analyzing to said central machine; and
updating said optimization algorithms according to said results.

31. The method of claim 30, further comprising copying said optimization algorithms from a stored optimization algorithm on said central machine.

32. The method of claim 30, further comprising executing said optimization algorithms on said nodes.

33. The method of claim 30, further comprising indicating to said central machine when said analyzing is complete.

34. A system for processing a data space over a distributed network having a plurality of nodes, comprising:
means for partitioning said data space into a plurality of data blocks on a central machine;
means for sending said plurality of data blocks to said plurality of nodes;
means for analyzing said plurality of data blocks at said plurality of nodes;
means for executing a plurality of optimization algorithms at said plurality of nodes, wherein each of said plurality of optimization algorithms correlate to each of said plurality of data blocks; and
means for updating said plurality of optimization algorithms at an interval from said central machine.

35. A computer program product comprising a computer useable medium having computer readable code embodied therein for processing a data space over a distributed network having a plurality of nodes, the computer program product adapted when run on a computer to execute steps, including:
processing a data space over a distributed network having a plurality of nodes, comprising:
partitioning said data space into a plurality of data blocks on a central machine;
sending said plurality of data blocks to said plurality of nodes;
analyzing said plurality of data blocks at said plurality of nodes;
executing a plurality of optimization algorithms at said plurality of nodes, wherein each of said plurality of optimization algorithms correlate to each of said plurality of data blocks; and
updating said plurality of optimization algorithms at an interval from said central machine.

36. A system for updating an optimization algorithm on a node within a distributed network, comprising:
means for receiving an update from a central machine coupled to said node, wherein said node analyzes a data block according to said optimization algorithm;
means for determining whether said update is applicable to said data block; and
means for modifying the order of analysis of said data block in accordance with said update.

37. A computer program product comprising a computer useable medium having computer readable code embodied therein for updating an optimization algorithm on a node within a distributed network, the computer program product adapted when run on a computer to execute steps, including:
updating an optimization algorithm on a node within a distributed network, comprising:
receiving an update from a central machine coupled to said node, wherein said node analyzes a data block according to said optimization algorithm;
determining whether said update is applicable to said data block; and
modifying the order of analysis of said data block in accordance with said update.

38. A system for processing data over a distributed network, comprising:
means for partitioning a data space into data blocks;
means for distributing said data blocks to nodes within said distributed network;
means for receiving optimization algorithms at said nodes from a central machine within said distributed network;
means for analyzing said data blocks at said nodes using said optimization algorithms;
means for forwarding results from said analyzing to said central machine; and
means for updating said optimization algorithms according to said results.

39. A computer program product comprising a computer useable medium having computer readable code embodied therein for processing data over a distributed network, the computer program product adapted when run on a computer to execute steps, including:
processing data over a distributed network, comprising:
partitioning a data space into data blocks;
distributing said data blocks to nodes within said distributed network;
receiving optimization algorithms at said nodes from a central machine within said distributed network;
analyzing said data blocks at said nodes using said optimization algorithms;
forwarding results from said analyzing to said central machine; and
updating said optimization algorithms according to said results.
